(19) United States
(12) Patent Application Publication
(10) Pub. No.: US 2011/0081036 A1
(43) Pub. Date: Apr. 7, 2011

(54) BALLISTIC HEADSET

(76) Inventor: Wayne Brown, Rocky Hill, CT (US)

(21) Appl. No.: 12/900,014

(22) Filed: Oct. 7, 2010

Related U.S. Application Data
(60) Provisional application No. 61/249,344, filed on Oct. 7, 2009.

(51) Int. Cl. H04R 1/10

(52) U.S. Cl. 381/375

(57) ABSTRACT

A ballistic headset comprises an ear cup that includes a shell made of a ballistic material. The shell may include one or more layers of the ballistic material, and a wire mesh sandwiched between two of the layers. The ear cup includes a cavity that houses one or more speakers and a filler material. An opening of the cavity may be covered with a wire mesh that prevents spall from passing toward the wearer's ear.

### CROSS-REFERENCE TO RELATED APPLICATIONS

This patent application claims priority to co-pending U.S. Provisional Patent Application No. 61/249,344, filed Oct. 7, 2009, entitled “Headset Whereby the Ear Cups are Constructed of or Have Applied Ballistic Resilient Material.” The disclosure of the provisional patent application is incorporated herein by reference in its entirety.

### BACKGROUND

Helmets made of impact-resistant material have been available to protect military personnel, law enforcement personnel and others in combat and other confrontational situations for many years. For example, in 1975, the U.S. Military introduced the Personnel Armor System Ground Troops Helmet (PASGT). The PASGT Helmet includes bulged side wings to allow for hearing protectors to fit underneath the side wings. The PASGT has given way to new helmets such as the Advanced Combat Helmet/Modular Integrated Communication Helmet (ACH/MICH). That helmet has a lighter weight and uses new Kevlar materials that is lighter and more comfortable for the wearer.

Notwithstanding the recent improvements in helmets, the cost of impact-hearing damage to United States defense personnel has escalated in recent years. This fact, and the need for the soldier to carry even greater weight in other areas, has led to a desire to improve military and law enforcement head and hearing protection.

This patent application is directed to a device that helps to resolve some or all of the problems described above.

### SUMMARY

In one general respect, the embodiments disclose a ballistic headset. The ballistic headset includes a microphone and a first ear cup comprising a housing that forms a cavity, a printed circuit board positioned within the cavity and electronically connected to receive signals the microphone, at least one a speaker positioned within the cavity and electronically connected to the circuit board to project sound corresponding to the signals outward from the cavity, wherein the ear cup further comprises a shell formed of a ballistic material.

### BRIEF DESCRIPTION OF THE DRAWINGS

FIG. 1 is a view of an exemplary ballistic headset, as worn by a person and viewed from the front of the person.

FIG. 2 is a view of the exemplary ballistic headset, viewed from the side of the person.

FIG. 3 illustrates an alternative embodiment, as viewed from the side of the person.

FIG. 4 illustrates a side view of an exemplary headset.

FIG. 5 illustrates a cut-away view showing exemplary components of an ear cup.

FIG. 6 illustrates an embodiment of an integral headset and goggle assembly.

### DETAILED DESCRIPTION

This disclosure is not limited to the particular methodologies, systems and materials described, as these may vary. The terminology used in this description is for the purpose of describing the particular versions or embodiments only, and is not intended to limit the scope. In addition, the word “comprising” as used in this document is intended to mean “including but not limited to.” Unless defined otherwise, all technical and scientific terms used herein have the same meanings as commonly understood by one of ordinary skill in the art.

As used in this document, the term “ballistic material” is a material suitable for protecting a user against serious injury from projectiles such as shrapnel. In some embodiments, ballistic materials are those that satisfy United States Department of Defense Standard MIL-STD-662, V₅₀ Ballistic Test for Armor. In some embodiments, ballistic materials may be those that will pass a V0 test using a 0.22 caliber, 17.0+/−0.5 grain, T37 shaped projectile at a velocity of 550 to 650 feet per second when tested as specified in United States Department of Defense Standard MIL-DTL-43511D. Suitable materials may include, for example, a polycarbonate or aramid material such as a aromatic polymide resin. Exemplary materials include, but are not limited to, those developed by E.I. DuPont de Nemours & Company and sold under the trademarks “Kevlar” or “Nomex”. Similarly, a high-strength polyethylene fiber may be used such as “Spectra Fiber” manufactured by AlliedSignal.

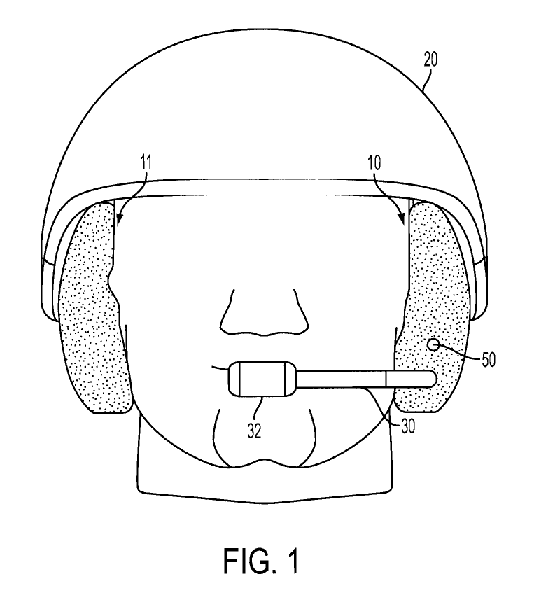

FIG. 1 illustrates an exemplary ballistic headset, as worn by a person such as military or law enforcement personnel. The user may wear a helmet body 20 that is formed of a ballistic material. The helmet body may be any ballistic helmet now or hereafter known, including but not limited to those described in U.S. Pat. No. 4,908,877 to White; U.S. Pat. No. 5,522,091 to Rudolf; and U.S. Pat. No. 5,603,117 to Hudner Jr. et al., the disclosures of which are each incorporated herein by reference in their entirety.

The ballistic headset may include two ear cups 10, 11, one for each of the user's ears. Alternatively, the headset may only include only a single ear cup 10 to cover only one of the user's ears. Each ear cup includes a housing (also referred to in this document as a shell) made of a ballistic material. Each ear cup is sized to completely fit over the ear of a typical adult. The headset also may also include a microphone 32 and stem 30. The stem 30 is attached to the ear cup 10 and the microphone 32, and it may be made of a rigid plastic, metal, polycarbonate, or other material. The stem 30 contains wiring to transmit electronic signals obtained by the microphone 32 and corresponding to the user's voice to the ear cup 10 so that the wearer may her his or her own voice. The ear cup 10, microphone 32, and/or stem 30 may house a transmitter that transmits signals corresponding to the user's voice to be picked up by an external receiver.

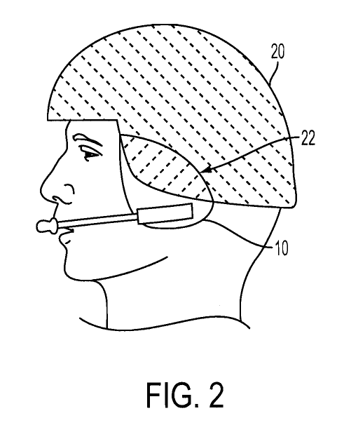

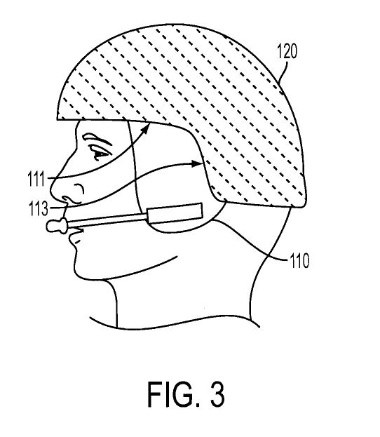

FIG. 2 illustrates an embodiment where the user's helmet 20 includes one or two ear cup housing receptacles 22 under which portion of each ear cup 10 may reside. The ear cup housing retainer may be a side panel that bumps outward to provide additional space under which the ear cup will fit. Alternatively, as shown in FIG. 3, if an alternative helmet 120 includes little or no section that covers the user's ears, then the ear cup 110 may substantially or completely fill the open area over the user's ears. In this embodiment, the ear cup's shell may be shaped on an upper portion 111 and a side portion 113 to substantially conform to the contour of the side wall of the helmet 120 that makes up the ear opening. Each helmet 20 and 120 may be adapted such that the ear cups 10 and 110 are removably affixed to their respective helmet. For example, helmet 20 may be adapted to include a slot or fixing point corresponding to a protrusion of other attachment feature on the ear cup 10.

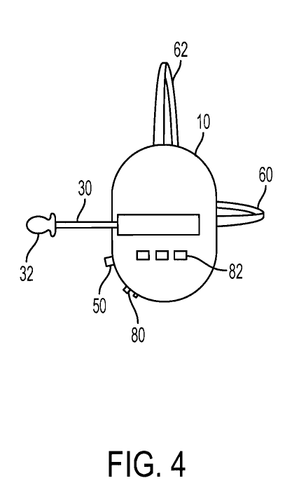

FIG. 4 illustrates an exemplary headset including an ear cup 10, stem 30 and microphone 32 as also shown in FIG. 1. Referring to FIG. 4, the headset may include one or more headbands, such as a crown strap 62 that fits over the user's crown and/or a rear strap 60 that fits behind the user's head. Either of these straps may be adjustable by one or more straps, interlocking connectors (such as those known as Velcro®, or other hook-and-link connectors), or other means. The headset also may include a microphone 50 to receive external sounds that may be processed within the ear cup for the user to hear. The headset also may include one or more controls, such as volume control dials or buttons, on/off switches, frequency adjustments, or other controls. Such controls 80 may be positioned on a rim of the ear cup, or the controls 82 may be positioned on a side of the ear cup.

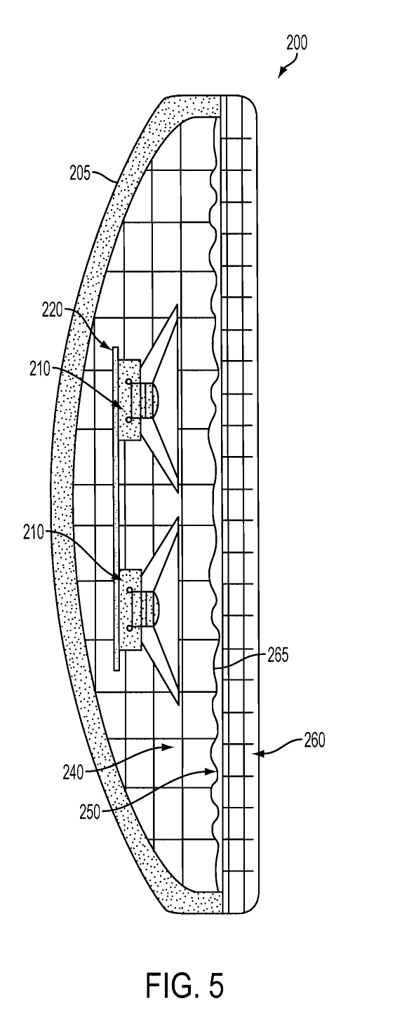

FIG. 5 illustrates an exemplary cross-sectional view of an ear cup 200 as used in the embodiments described in this document. The ear cup 200 may include a shell 205 made of a ballistic material. The shell 205 may include one or more layers of the ballistic material. Optionally, the shell may include a reinforcement layer, such as a wire or nylon mesh material, that is sandwiched between two layers of the ballistic material. Optionally, any number of layers of ballistic material and mesh may be used to form the shell. In any of these situations, the shell may be formed by any suitable method. For example, the layer or layers of ballistic material and/or mesh may be vacuum-formed using now or hereafter known vacuum-forming methods.

When mesh is used, it may be of any suitable size or gage, and preferably having of forming a grid size that is sufficient to block spall (i.e., chips, fragments or debris that may be produced from spalling of the projectiles or other material) that may be directed toward the wearer's head. Exemplary materials are disclosed, for example, in U.S. Patent Application Pub. No. 2007/0283801 filed by Gallo, the disclosure of which is incorporated herein by reference in its entirety. Optionally, the mesh may provide a shield (e.g., a faraday shield) that is effective to reduce or disperse electromagnetic shock waves or electromagnetic interference (EMI) pulses that would otherwise damage the wearer's ear. The power of an electromagnetic pulse is oppositely proportional to the frequency of the pulse. Thus, for a typical electromagnetic pulse, the larger the frequency of the signal, the weaker the strength of the signal will be. To produce an effective electromagnetic pulse, generally a low frequency signal is used having a large wavelength. To effectively shield against an electromagnetic pulse, the mash grid size may be a fraction of the wavelength. For example, the above referenced mesh having a 0.2 inch grid may be sufficient to protect against most high power electromagnetic pulses. However, this grid size may not be suitable to protect against most sizes of spall. Thus, multiple layers of mesh may be incorporated, or a single layer of mesh having a grid size that protects against a majority of spall sizes and electromagnetic pulses. Exemplary materials are disclosed, for example, in U.S. Patent Application Pub. No. 6,266,824 to Giansanti, the disclosure of which is incorporated herein by reference in its entirety, and may include, but are not limited to, steel, carbon fiber, aluminum, polycarbonates, aramids, Kevlar, polyethylene fiber, and other suitable materials.

The ear cup may include a cavity that contains one or more speakers 210 which may be mounted on a printed circuit board 220 and directed to deliver sound signals toward the wearer's ear. The printed circuit board receives signals from either of the outer microphones (e.g., microphones 30 and 50 as shown in FIGS. 1 and 4), and processes them for output through the speakers 220 toward the speaker cover 265. The speaker cover 265 may be made of nylon or other fabric, or other suitable material, and passes sound while protecting the inner components of the ear cup. The open space around the speakers in the cavity may be filled with foam 240, gel, and/or other suitable filler material.

Optionally, over or under or integral with or in lieu of the speaker cover 265, the ear cup may include a wire or nylon mesh 250 that provides additional resistance to impact in the event that the shell 205 may be compromised by a projectile. The mesh 265 will substantially or completely cover the opening that exists between the speakers 210 and the wearer's ear, and it may be secured to the shell 205 under the cushion 260.

The ear cup may also include a cushion 260 that is positioned to contact the user's head when worn and surround the user's ear. The cushion 260 may be made of any suitable padding material, such as foam, gel, plastic, rubber, fabric, and/or other materials. It will be sized to surround the user's ear and help block or attenuate sound and thus help the wearer focus on sounds that are allowed in through the microphones and speakers. The cushion 260 will be attached to the shell 205, optionally via one or more intermediate structures such as a gasket that is positioned between the cushion and the shell.

The printed circuit board may be programmed with, or it may include hardware to provide, noise-canceling or noise attenuating functions now or hereafter known to those of skill in the art. The ear cup also may have external or internal fitted electronics to provide impact noise suppression, active talk through, or active noise reduction (ANR). For example, a microphone may be operably connected to the printed circuit board for obtaining any ambient sound around the wearer of the helmet. The printed circuit board may include sound processing circuitry configured to detect a wavelength of the ambient sound, and produce an inverted wavelength. The inverted wavelength may be emitted via a speaker in the ear cup to reduce or eliminate the ambient noise as heard by the wearer.

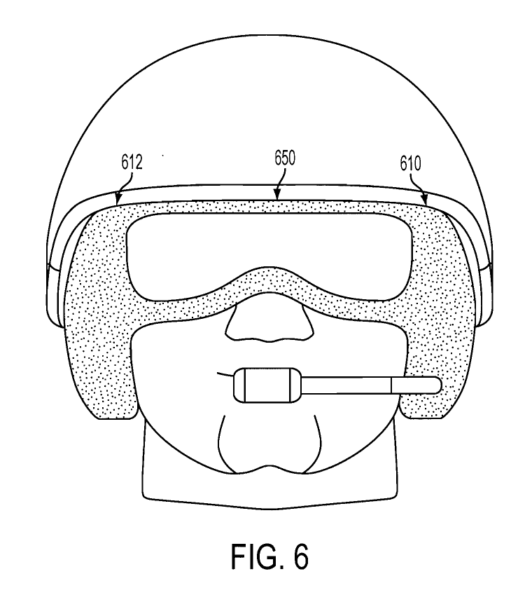

FIG. 6 illustrates an alternate embodiment in which the headset is integral with ballistic goggles. In this embodiment, the ear cups 610 and 612 may include material and structure similar to those described above in the discussion of FIGS. 1-5. However, each ear cup is attached to a frame of a goggle 650 that is also made of a ballistic material. The goggle frame 650 may be made of the same ballistic material that is used to form the housings of each ear cup 610, 612, or the goggle frame may be formed of a different ballistic material. Each ear cup may be removably attached to the frame by clips, tabs, hooks, straps, or other removable attachment means. The removable attachment means may be integrated into each ear cup 610, 612. Alternatively, the removable attachment means may be integrated into the goggle frame 650.

Optionally, in any of the embodiments described above, the ballistic material and/or mesh may be coated with a material to provide additional ballistic protection. Suitable materials include a ballistics grade polymer, a polycarbonate or aramid material such as a aromatic polymide resin, Kevlar, polyethylene fiber, or another similar material. Suitable ballistic materials and coatings are described, for example, in U.S. Pat. No. 4,737,402 Harpell et al.; U.S. Pat. No. 5,734,434 to Thomas; U.S. Pat. No. 6,846,454 to Thomas; and U.S. Pat. 7,276,458 to Wen, the disclosures of which are each incorporated herein by reference in their entirety.

The above-disclosed and other features and functions, or alternatives thereof, may be combined into many other different systems or applications. Various presently unforeseen or unanticipated alternatives, modifications, variations or improvements in the embodiments described above may be made by those skilled in the art, and are also intended to be encompassed by the following claims.

What is claimed is:

1. A ballistic headset comprising:
a microphone; and
a first ear cup comprising a housing that forms a cavity, a printed circuit board positioned within the cavity and electronically connected to receive signals the microphone, at least one a speaker positioned within the cavity and electronically connected to the circuit board to project sound corresponding to the signals outward from the cavity;
wherein, the ear cup further comprises a shell formed of a ballistic material.

2. The headset of claim 1, further comprising:
a cushion that is positioned to attach to the shell and, when worn by a user, contact the user's head around the user's ear to snugly fit the ear cup to the user's head.

3. The headset of claim 1, wherein the shell comprises:
a first layer of the ballistic material;
a second layer of the ballistic material;
a mesh layer positioned between the first layer and the second layer.

4. The headset of claim 3, wherein the mesh layer comprises a first mesh and a second mesh, wherein the first and second mesh have different grid sizes.

5. The headset of claim 4, wherein the first mesh grid is sized to prevent spall from penetrating the shell, and the second mesh grid is sized to eliminate electromagnetic pulses.

6. The headset of claim 2, wherein the cavity provides an opening positioned to be placed over the ear, and the headset further provides a spall-resistant mesh that covers the opening.

7. The headset of claim 1, wherein the shell is shaped on at least two sides so that, when worn, the shell substantially conforms to a side wall of a helmet and fill an ear opening that is provided by the helmet.

8. The headset of claim 7, wherein the shell is removably affixed to the helmet.

9. The headset of claim 1, further comprising:
a goggle comprising a frame of a ballistic material;
wherein the frame is removably secured to the ear cup.

10. The headset of claim 9, wherein the shell comprises:
a first layer of the ballistic material;
a second layer of the ballistic material;
a mesh layer positioned between the first layer and the second layer.
